(19) United States
(12) Patent Application Publication
(10) Pub. No.: US 2025/0382538 A1
(43) Pub. Date: Dec. 18, 2025

(54) FRICTION REDUCING COATINGS

(71) Applicant: General Electric Company, Cincinnati, OH (US)

(72) Inventors: Paul Mathew, Bengaluru (IN); Souvik Math, Bengaluru (IN); Patrick Shower, Nassau, NY (US); Harsha Kikkari Anantha Rao, Bengaluru (IN); Ravindra Shankar Ganiger, Bengaluru (IN); Matthew D. Brothers, Cincinnati, OH (US)

(21) Appl. No.: 18/743,619

(22) Filed: Jun. 14, 2024

(51) Int. Cl. C10M 103/04; C09D 5/03; C09D 7/61; C10N 10/12; C10N 10/16; C10N 30/06; C10N 40/25; C10N 50/00; C10N 50/08

(52) U.S. Cl. CPC C10M 103/04; C09D 5/032; C09D 7/61; C10M 2201/05; C10N 2010/12; C10N 2010/16; C10N 2030/06; C10N 2040/25; C10N 2050/025; C10N 2050/08

(57) ABSTRACT

A coating to reduce friction, the coating including an amorphous metal, and a solid lubricant. The solid lubricant may be dispersed with the amorphous metal throughout the coating, or the solid lubricant may form a layer on top of the amorphous metal. The coating may be applied to various components such as aircraft components, gas turbine engine components, etc., to reduce friction.

### TECHNICAL FIELD

The present disclosure relates to coating materials, coated substrates, textured surfaces, textured components, and methods of reducing friction generated by, for example, bearings, gears, bushings, or spline shafts in gas turbine engines for aircraft.

### BACKGROUND

Gas turbine engines include surfaces that mechanically contact each other. Mechanical contacts may be subjected to friction that may degrade the performance of various systems, generate heat, and cause wear.

### BRIEF DESCRIPTION OF THE DRAWINGS

Features and advantages of the present disclosure will be apparent from the following description of various exemplary embodiments, as illustrated in the accompanying drawings, wherein like reference numbers generally indicate identical, functionally similar, and/or structurally similar elements.

FIG. 1 is a schematic view of an aircraft having a gas turbine engine according to an embodiment of the present disclosure.

FIG. 2 is a cross-sectional view taken along line 2-2 in FIG. 2, of the gas turbine engine of the aircraft shown in FIG. 2.

FIG. 3 is a partial cross-sectional view of a bearing having a friction reducing coating and/or having a textured surface according to an embodiment of the present disclosure.

FIG. 4 is a partial cross-sectional view of a bearing having a friction reducing coating and/or having a textured surface according to an embodiment of the present disclosure.

FIG. 5 is a partial cross-sectional view of a journal bearing having a friction reducing coating and/or having a textured surface according to an embodiment of the present disclosure.

FIG. 6 is a cross-sectional view of a squeeze film damper having a friction reducing coating and/or having a textured surface according to an embodiment of the present disclosure.

FIG. 7 is a cross-sectional view of a mechanical seal having a friction reducing coating and/or having a textured surface according to an embodiment of the present disclosure.

FIG. 8 is a partial cross-sectional view of a mechanical seal having a friction reducing coating and/or having a textured surface according to an embodiment of the present disclosure.

FIG. 9 is a partial cross-sectional view of a mechanical seal having a friction reducing coating and/or having a textured surface according to an embodiment of the present disclosure.

FIG. 10 is a schematic view of spline shafts having a friction reducing coating and/or having a textured surface according to an embodiment of the present disclosure.

FIG. 11 is a schematic view of gears having a friction reducing coating and/or having a textured surface according to an embodiment of the present disclosure.

FIGS. 12A and 12B depict friction and wear data for an uncoated disk and a disk coated with a friction reducing coating according to an embodiment of the present disclosure. FIG. 12A depicts friction reduction data for a disk coated with a friction reducing coating according to an embodiment of the present disclosure. FIG. 12B depicts wear reduction data for a disk coated with a friction reducing coating according to an embodiment of the present disclosure.

FIG. 13 depicts friction reduction for a textured surface as compared to a smooth surface.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the scope of the disclosure as claimed.

Various embodiments are discussed in detail below. While specific embodiments are discussed, this is done for illustration purposes only. A person skilled in the relevant art will recognize that other components and configurations may be used without departing from the present disclosure.

The terms “forward” and “aft” refer to relative positions within a gas turbine engine or vehicle and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows. The term “fluid” may be a gas or a liquid. The term “fluid communication” means that a fluid is capable of making the connection between the areas specified.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

As used herein, an alloy is “based” on a particular element when that element is present in the alloy at the greatest weight percent, by total weight of the alloy, of all elements contained in the alloy. For example, an iron-based alloy has a higher weight percentage of iron than any other single element present in the alloy.

The singular forms “a,” “an,” and “the” include plural references unless the context clearly dictates otherwise.

Here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other.

As noted above, friction and wear may occur at mechanical contacts, e.g., between components of a gas turbine engine. For example, friction and wear may occur in bearings, seals, gears, and spline shafts. Friction and wear can degrade the performance of various systems and components, generate heat, and decrease the useful lifetime of a component.

Friction reducing coatings and/or texturing can be applied to various surfaces and components to reduce friction and wear. The friction reducing coatings and/or texturing may be applied to any surface or component that could experience friction and/or wear and is not limited to any particular application. Some non-limiting examples of suitable surfaces and components include aircraft components, gas turbine engine components, rail-car components (e.g., bearings, gears, and/or shafts), automobile components (e.g., bearings, gears, and/or shafts), bearings (e.g., fan bearings, pitch bearings, and/or main module bearings), seals (e.g., carbon seals), gears (e.g., gears of a gear box and/or a transmission), and shafts (e.g., a spline shaft). Some nonlimiting examples related to aircraft and/or gas turbine engines (e.g., a gas turbine for an aircraft, a terrestrial gas turbine engine such as for a power plant, and/or a maritime gas turbine engine for a ship) are described in more detail below.

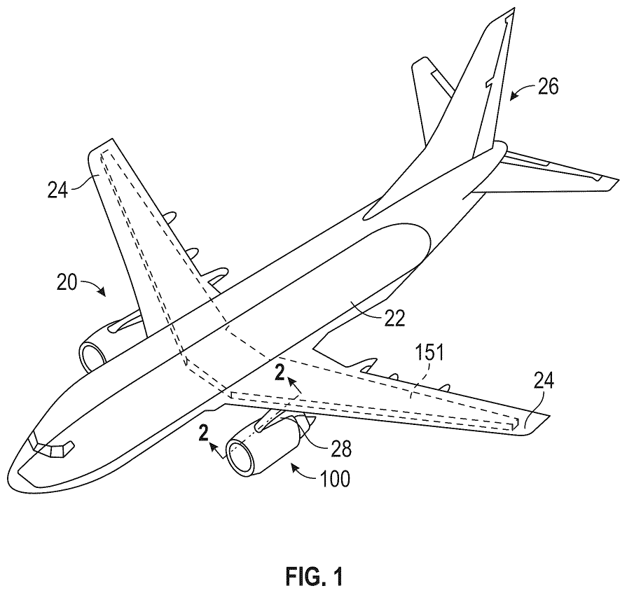

FIG. 1 shows an aircraft 20 that may implement various embodiments. The aircraft 20 includes a fuselage 22, wings 24 attached to the fuselage 22, and an empennage 26. The aircraft 20 also includes a propulsion system that produces a propulsive thrust required to propel the aircraft 20 in flight, during taxiing operations, and the like. The propulsion system for the aircraft 20 shown in FIG. 1 includes a pair of engines 100. In this embodiment, each engine 100 is attached to one of the wings 24 by a pylon 28 in an under-wing configuration. Although the engines 100 are shown attached to the wing 24 in an under-wing configuration in FIG. 1, in other embodiments, the engine 100 may have alternative configurations and be coupled to other portions of the aircraft 20. For example, the engine 100 may additionally or alternatively include one or more aspects coupled to other parts of the aircraft 20, such as, for example, the empennage 26, and the fuselage 22.

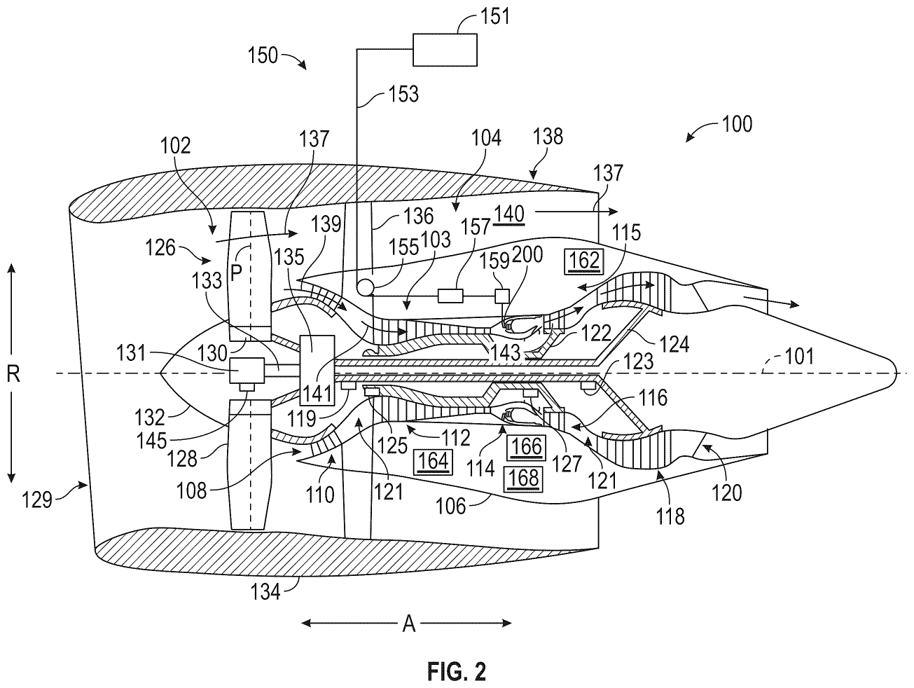

As will be described further below, with reference to FIG. 2, the engines 100 shown in FIG. 1 are gas turbine engines that are each capable of selectively generating a propulsive thrust for the aircraft 20. The amount of propulsive thrust may be controlled at least in part based on a volume of fuel provided to the engine 100 (e.g., a gas turbine engine) via a fuel system 150. An aviation turbine fuel in the embodiments discussed herein is a combustible hydrocarbon liquid fuel, such as a kerosene-type fuel, having a desired carbon number, a synthetic aviation fuel, a biofuel, a biodiesel, an ethanol, a bioalcohol, and the like. The fuel is stored in a fuel tank 151 of the fuel system 150. As shown in FIG. 1, at least a portion of the fuel tank 151 is located in each wing 24 and a portion of the fuel tank 151 is located in the fuselage 22 between the wings 24. The fuel tank 151, however, may be located at other suitable locations in the fuselage 22 or the wings 24. The fuel tank 151 may also be located entirely within the fuselage 22 or the wings 24. The fuel tank 151 may also be separate tanks instead of a single, unitary body, such as, for example, two tanks each located within a corresponding wing 24.

Although the aircraft 20 shown in FIG. 1 is an airplane, the embodiments described herein may also be applicable to other aircraft 20, including, for example, helicopters and unmanned aerial vehicles (UAV). The aircraft discussed herein are fixed-wing aircraft or rotor aircraft that generate lift by aerodynamic forces acting on, for example, a fixed wing (e.g., the wing 24) or a rotary wing (e.g., a rotor of a helicopter), and are heavier-than-air aircraft, as opposed to lighter-than-air aircraft (such as a dirigible). Further, although not depicted herein, in other embodiments, the gas turbine engine may be any other suitable type of gas turbine engine, such as an industrial gas turbine engine incorporated into a power generation system, a nautical gas turbine engine, etc.

FIG. 2 is a schematic, cross-sectional view of one of the engines 100 used in the propulsion system for the aircraft 20 shown in FIG. 1. The cross-sectional view of FIG. 2 is taken along line 2-2 in FIG. 1. For the embodiment depicted in FIG. 2, the engine 100 is a high bypass engine. The engine 100 has an axial direction A (extending parallel to a longitudinal centerline axis 101, shown for reference in FIG. 2), a radial direction R, and a circumferential direction. The circumferential direction (not depicted in FIG. 2) extends in a direction rotating about the axial direction A. The engine 100 includes a fan section 102 and a turbo-engine 104 disposed downstream from the fan section 102.

The turbo-engine 104 depicted in FIG. 2 includes, in serial flow relationship, a compressor section 103, a combustion section 114, and a turbine section 115. The turbo-engine 104 is substantially enclosed within an outer casing 106 that is substantially tubular and defines a core inlet 108. The core inlet 108 is annular in the depicted embodiment. As schematically shown in FIG. 2, the compressor section 103 includes a booster or a low pressure (LP) compressor 110 followed downstream by a high pressure (HP) compressor 112. The combustion section 114 is downstream of the compressor section 103. The turbine section 115 is downstream of the combustion section 114 and includes a high pressure (HP) turbine 116 followed downstream by a low pressure (LP) turbine 118. The turbo-engine 104 further includes a jet exhaust nozzle section 120 that is downstream of the turbine section 115, a high-pressure (HP) shaft 122 or a spool, and a low-pressure (LP) shaft 124. The HP shaft 122 drivingly connects the HP turbine 116 to the HP compressor 112. The HP turbine 116 and the HP compressor 112 rotate in unison through the HP shaft 122. The LP shaft 124 drivingly connects the LP turbine 118 to the LP compressor 110. The LP turbine 118 and the LP compressor 110 rotate in unison through the LP shaft 124. The HP shaft 122 may be in contact with a forward bearing 119 and an aft bearing 123 to reduce friction associated with rotating the HP shaft 122. Similarly, the LP shaft 124 may be in contact with a forward bearing 125 and an aft bearing 127 to reduce friction associated with rotating the LP shaft 124. One or more of the bearings (119, 123, 125, and/or 127) may be coated with a friction reducing coating and/or have a textured surface to reduce friction. The compressor section 103, the combustion section 114, the turbine section 115, and the jet exhaust nozzle section 120 together define a core air flow path 121 through which core air 139 flows.

The fan section 102 shown in FIG. 2 includes a fan 126 (e.g., a variable pitch fan) having a plurality of fan blades 128 coupled to a disk 130 in a spaced apart manner. As depicted in FIG. 2, the fan blades 128 extend outwardly from the disk 130 generally along the radial direction R. In the case of a variable pitch fan, the plurality of fan blades 128 are rotatable relative to the disk 130 about a pitch axis P by virtue of the fan blades 128 being operatively coupled to an actuation member 131 configured to collectively vary the pitch of the fan blades 128 in unison. This system for adjusting the pitch of the fan blades 128 may include one or more pitch bearings 145 to permit rotation of the fan blades 128 and to change the pitch of the fan blades 128, and the one or more pitch bearings 145 may be coated with a friction reducing coating and/or have a textured surface to reduce friction. The fan blades 128, the disk 130, and the actuation member 131 are together rotatable about the longitudinal centerline axis 101 via a fan shaft 133 that is powered by the LP shaft 124 across a power gearbox, also referred to as a gearbox assembly 135. In this way, the fan 126 is drivingly coupled to, and powered by, the turbo-engine 104, and the engine 100 is an indirect drive engine. The gearbox assembly 135 may be a reduction gearbox assembly for adjusting the rotational speed of the fan shaft 133 and, thus, the fan 126 relative to the LP shaft 124 when power is transferred from the LP shaft 124 to the fan shaft 133. The gearbox assembly 135 includes gears and the gears can be coated with a friction reducing coating and/or have a textured surface to reduce friction.

Referring still to the exemplary embodiment of FIG. 2, the disk 130 is covered by a fan hub 132 that is aerodynamically contoured to promote an airflow through the plurality of fan blades 128. In addition, the fan section 102 includes an annular fan casing or a nacelle 134 that circumferentially surrounds the fan 126 and at least a portion of the turbo-engine 104. The nacelle 134 is supported relative to the turbo-engine 104 by a plurality of outlet guide vanes 136 that are circumferentially spaced about the nacelle 134 and the turbo-engine 104. Moreover, a downstream section 138 of the nacelle 134 extends over an outer portion of the turbo-engine 104, and, with the outer casing 106, defines a bypass airflow passage 140 therebetween.

During operation of the engine 100, a volume of air enters the turbine engine (e.g., engine 100) through an engine inlet 129 of the nacelle 134 or the fan section 102. As the volume of air passes across the fan blades 128, a first portion of air, also referred to as bypass air 137, is routed into the bypass airflow passage 140, and a second portion of air, also referred to as core air 139, is routed into the upstream section of the core air flow path 121 through the core inlet 108 of the LP compressor 110. The ratio between the bypass air 137 and the core air 139 is commonly known as a bypass ratio. The pressure of the core air 139 is then increased in the compressor section 103 and, more specifically, the LP compressor 110, generating compressed air 141. The compressed air 141 is routed through the HP compressor 112, where the compressed air 141 is further compressed, and into the combustion section 114, where the compressed air 141 is mixed with fuel and ignited to generate combustion gases 143.

The combustion gases 143 are routed into the HP turbine 116 and expanded through the HP turbine 116 where a portion of thermal energy or kinetic energy from the combustion gases 143 is extracted via one or more stages of HP turbine stator vanes and HP turbine rotor blades that are coupled to the HP shaft 122. This causes the HP shaft 122 to rotate, which supports operation of the HP compressor 112 (self-sustaining cycle). In this way, the combustion gases 143 do work on the HP turbine 116. The combustion gases 143 are then routed into the LP turbine 118 and expanded through the LP turbine 118. Here, a second portion of the thermal energy or the kinetic energy is extracted from the combustion gases 143 via one or more stages of LP turbine stator vanes and LP turbine rotor blades that are coupled to the LP shaft 124. This causes the LP shaft 124 to rotate, which supports operation of the LP compressor 110 (self-sustaining cycle) and rotation of the fan 126 via the gearbox assembly 135. In this way, the combustion gases 143 do work on the LP turbine 118.

The combustion gases 143 are subsequently routed through the jet exhaust nozzle section 120 of the turbo-engine 104 to provide propulsive thrust. Simultaneously, the bypass air 137 is routed through the bypass airflow passage 140 before being exhausted from a fan nozzle exhaust section of the engine 100, also providing propulsive thrust. The HP turbine 116, the LP turbine 118, and the jet exhaust nozzle section 120 at least partially define a hot gas path for routing the combustion gases 143 through the turbo-engine 104.

The engine 100 is operable with the fuel system 150 and receives a flow of fuel from the fuel system 150. The fuel system 150 includes a fuel delivery assembly 153 providing the fuel flow from the fuel tank 151 to the engine 100, and, more specifically, to a plurality of fuel injectors 200 that inject fuel into a combustion chamber of a combustor of the combustion section 114.

The components of the fuel system 150, and, more specifically, the fuel tank 151, is an example of a fuel source that provides fuel to the fuel injectors 200, as discussed in more detail below. The fuel delivery assembly 153 includes tubes, pipes, conduits, and the like, to fluidly connect the various components of the fuel system 150 to the engine 100. The fuel tank 151 is configured to store the hydrocarbon fuel, and the hydrocarbon fuel is supplied from the fuel tank 151 to the fuel delivery assembly 153. The fuel delivery assembly 153 is configured to carry the hydrocarbon fuel between the fuel tank 151 and the engine 100 and, thus, provides a flow path (fluid pathway) of the hydrocarbon fuel from the fuel tank 151 to the engine 100.

The fuel system 150 includes at least one fuel pump fluidly connected to the fuel delivery assembly 153 to induce the flow of the fuel through the fuel delivery assembly 153 to the engine 100. One such pump is a main fuel pump 155. The main fuel pump 155 is a high-pressure pump that is the primary source of pressure rise in the fuel delivery assembly 153 between the fuel tank 151 and the engine 100. The main fuel pump 155 may be configured to increase a pressure in the fuel delivery assembly 153 to a pressure greater than a pressure within a combustion chamber of the combustor.

The fuel system 150 also includes a fuel metering unit 157 in fluid communication with the fuel delivery assembly 153. Any suitable fuel metering unit 157 may be used including, for example, a metering valve. The fuel metering unit 157 is positioned downstream of the main fuel pump 155 and upstream of a fuel manifold 159 configured to distribute fuel to the fuel injectors 200. The fuel system 150 is configured to provide the fuel to the fuel metering unit 157, and the fuel metering unit 157 is configured to receive fuel from the fuel tank 151. The fuel metering unit 157 is further configured to provide a flow of fuel to the engine 100 in a desired manner. More specifically, the fuel metering unit 157 is configured to meter the fuel and to provide a desired volume of fuel, at, for example, a desired flow rate, to the fuel manifold 159 of the engine 100. The fuel manifold 159 is fluidly connected to the fuel injectors 200 and distributes (provides) the fuel received to the plurality of fuel injectors 200, where the fuel is injected into the combustion chamber and combusted. Adjusting the fuel metering unit 157 changes the volume of fuel provided to the combustion chamber and, thus, changes the amount of propulsive thrust produced by the engine 100 to propel the aircraft 20.

The engine 100 also includes various accessory systems to aid in the operation of the engine 100 and/or an aircraft that includes the engine 100. For example, the engine 100 may include a main lubrication system 162, a compressor cooling air (CCA) system 164, an active thermal clearance control (ATCC) system 166, and a generator lubrication system 168. The main lubrication system 162 is configured to provide a lubricant to, for example, various bearings and gear meshes in the compressor section, the turbine section, the HP shaft 122, and the LP shaft 124. The lubricant provided by the main lubrication system 162 may increase the useful life of such components and may remove a certain amount of heat from such components through the use of one or more heat exchangers. The compressor cooling air (CCA) system 164 provides air from one or both of the HP compressor 112 or the LP compressor 110 to one or both of the HP turbine 116 or the LP turbine 118. The active thermal clearance control (ATCC) system 166 acts to minimize a clearance between tips of turbine blades and casing walls as casing temperatures vary during a flight mission. The generator lubrication system 168 provides lubrication to an electronic generator (not shown), as well as cooling/heat removal for the electronic generator. The electronic generator may provide electrical power to, for example, a startup electrical motor for the engine 100 and/or various other electronic components of the engine 100 and/or an aircraft including the engine 100. The lubrication systems for the engine 100 (e.g., the main lubrication system 162 and the generator lubrication system 168) may use hydrocarbon fluids, such as oil, for lubrication, in which the oil circulates through inner surfaces of oil scavenge lines.

The engine 100 discussed herein is provided by way of example only. In other embodiments, any other suitable engine may be utilized with aspects of the present disclosure. For example, in other embodiments, the engine may be any other suitable gas turbine engine, such as a turboshaft engine, a turboprop engine, a turbojet engine, an unducted single fan engine, and the like. In such a manner, in other embodiments, the gas turbine engine may have other suitable configurations, such as, direct drive configurations, fixed pitch fans, or other suitable numbers or arrangements of shafts, compressors, turbines, fans, etc. Further, although a particular engine 100 is depicted in FIG. 2, the friction reducing coating and/or textured surface may be used more generally and/or with other engine embodiments. For example, in alternative embodiments, aspects of the present disclosure may be incorporated into, or otherwise utilized with any other type of engine, such as reciprocating engines. Additionally, in still other exemplary embodiments, the exemplary engine 100 may include or be operably connected to any other suitable accessory systems. Additionally, or alternatively, the exemplary engine 100 may not include or be operably connected to one or more of the accessory systems 162, 164, 166, and 168, discussed above.

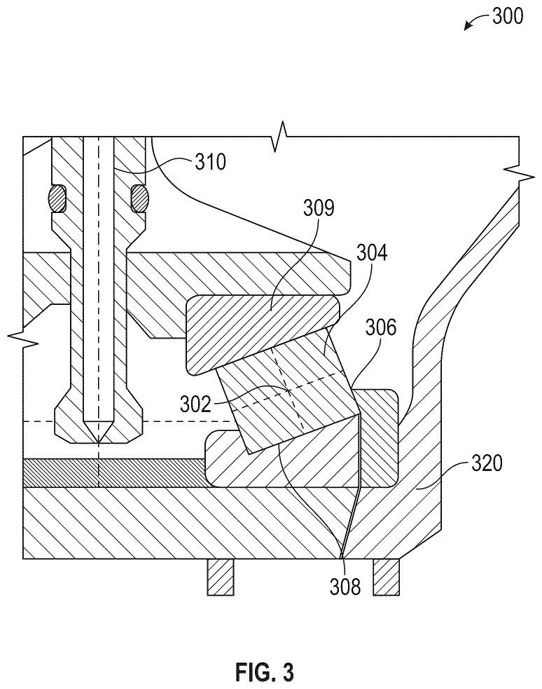

The preceding discussion is by way of example only and the friction reducing coating and/or textured surface may be applied to any component that experiences friction under normal operation such as bearings, seals, gears, and/or shafts. For example, the friction reducing coating and/or textured surface may be applied to a substrate that is a bearing raceway, a squeeze film damper, a ball of a ball bearing, a tapered roller of a roller bearing, a cylindrical roller of a roller bearing, a journal bearing component, or a needle roller of a roller bearing. Some additional nonlimiting examples of such components are depicted in FIGS. 3 to 11 as discussed below.

FIG. 3 is a partial cross-sectional view of a bearing having a friction reducing coating and/or having a textured surface according to an embodiment of the present disclosure. FIG. 3 depicts a main module bearing 300. The main module bearing 300 facilitates motion between two components, such as a static component 310 and a rotational component 320. For example, the main module bearing 300 can support the fan shaft 133 (FIG. 2) as the rotational component 320. The main module bearing 300 can be the forward bearing 119 (FIG. 2) or the aft bearing 123 supporting the HP shaft 122 as the rotational component 320 or the main module bearing 300 can be the forward bearing 125 (FIG. 2) or the aft bearing 127 (FIG. 2) supporting the LP shaft 124 (FIG. 2) as the rotational component 320. The bearing depicted in FIG. 3 is a roller bearing having a roller 302. The roller 302 includes an end portion 304 and a shoulder portion 306. The roller 302 depicted in FIG. 3 is a cylindrical roller, more specifically, a circular cylindrical roller, but the roller 302 can have other suitable shapes including, for example, balls, needles, tapered rollers, or convex rollers. The roller 302 is in contact with a first bearing portion 308 attached or otherwise connected to the rotational component 320and a second bearing portion 309, attached or otherwise connected to the static component 310. One or both of the first bearing portion 308 and the second bearing portion 309 can include a raceway in which the rollers 302 move. In the embodiment depicted in FIG. 3, the first bearing portion 308 includes a raceway, which is a groove formed in the first bearing portion 308. The first bearing portion 308 and the second bearing portion 309 sandwich the roller 302. As noted above, the rotational component 320 is connected to or otherwise in contact with the main module bearing 300, and the main module bearing 300 facilitates rotation of the rotational component 320 by motion of the roller 302 along the raceway. Any of the surfaces depicted in the main module bearing 300 that experience friction under normal operation may be coated with a friction reducing coating and/or have a textured surface to reduce friction and/or wear at the surface. For example, one or more surfaces of the roller 302 (such as the end portion 304 and/or the shoulder portion 306) may be coated with the friction reducing coating and/or have a textured surface to reduce friction and/or wear at the surface. Likewise, one or more of the contact surfaces of the first bearing portion 308, such as the raceway, and the second bearing portion 309 may be coated with the friction reducing coating and/or have a textured surface to reduce friction and/or wear at the surface. The main module bearing 300 may be, for example, a subassembly of any component disclosed herein having a bearing such as, for example, the forward bearing 119, the aft bearing 123, the forward bearing 125, the aft bearing 127, and/or the pitch bearing 145. For example, the bearing may be a main module bearing such that the rotational component 320 is the HP shaft 122 or LP shaft 124.

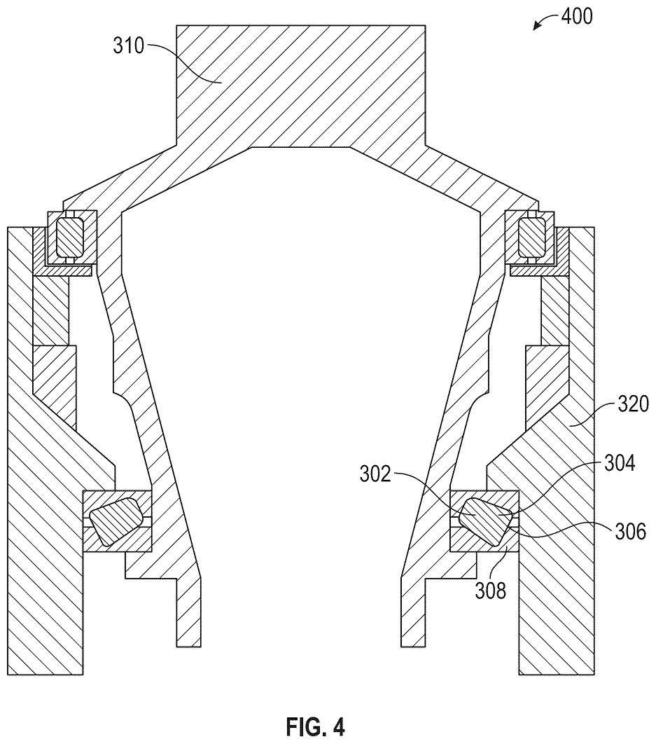

FIG. 4 is a partial cross-sectional view of a bearing having a friction reducing coating and/or having a textured surface according to an embodiment of the present disclosure. FIG. 4 depicts a pitch bearing 400 having a roller 302. For example, pitch bearing 400 can be the pitch bearing 145 that supports the fan blade 128 as depicted in FIG. 2. The roller 302 includes an end portion 304 and a shoulder portion 306. The roller 302 depicted in FIG. 4 is a conical roller having a tapered diameter along a length of the roller 302. The discussion of the main module bearing 300 in FIG. 3 also applies equally to the pitch bearing 400 depicted in FIG. 4. The pitch bearing 400 may be, for example, a subassembly of any component disclosed herein having a bearing such as, for example, the pitch bearing 145.

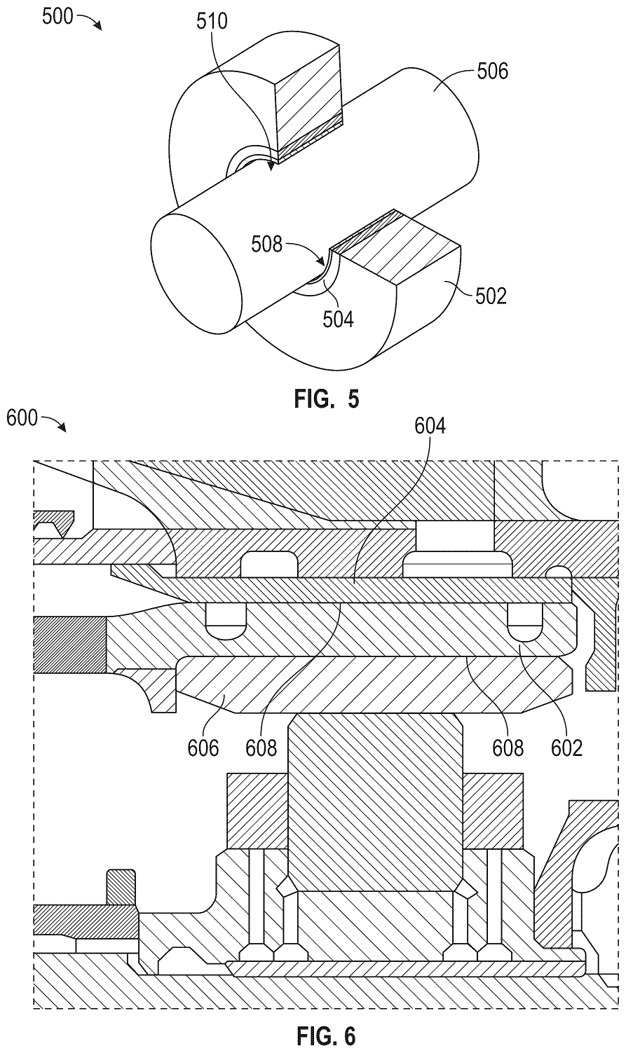

FIG. 5 is a partial cross-sectional view of a journal bearing having a friction reducing coating and/or having a textured surface according to an embodiment of the present disclosure. FIG. 5 depicts a journal bearing assembly 500. The journal bearing assembly 500 has a journal bearing housing 502 including a liner or a sleeve 504 in contact with a shaft 506. The liner or the sleeve 504 has a contact region 508 for contacting a surface 510 of the shaft 506. The shaft 506 may rotate within the journal bearing assembly 500 around a longitudinal axis that may cause friction between the contact region 508 and the surface 510. The contact region 508 and/or the surface 510 may be coated with a friction reducing coating and/or have a textured surface to reduce friction and/or wear associated with motion (e.g., rotational motion) of the shaft 506 against the journal bearing housing 502. The journal bearing assembly 500 may be, for example, a subassembly of any component disclosed herein having a journal bearing including, for example, a squeeze film damper or a reduction gear box.

FIG. 6 is a cross-sectional view of a squeeze film damper having a friction reducing coating and/or having a textured surface according to an embodiment of the present disclosure. FIG. 6 depicts a bearing assembly 600. The bearing assembly 600 has a squeeze film damper 602 between a housing component 604 and a bearing component 606. The squeeze film damper 602 may be effective for damping undesired vibrations that can occur during operation of the bearing assembly 600 by, e.g., providing viscous damping to the undesired vibrations. During normal operation of the bearing assembly 600, rotational motion of the bearing component 606 may also cause friction at one or more surfaces 608 of the squeeze film damper 602. The one or more surfaces 608 of the squeeze film damper 602 may be coated be with a friction reducing coating and/or have a textured surface to reduce friction and/or wear associated with motion of the bearing component 606 against the squeeze film damper 602. Bearing assembly 600 may be, for example, a subassembly of any component disclosed herein having a bearing such as, for example, the forward bearing 119, the aft bearing 123, the forward bearing 125, the aft bearing 127, and/or the pitch bearing 145 depicted in FIG. 4.

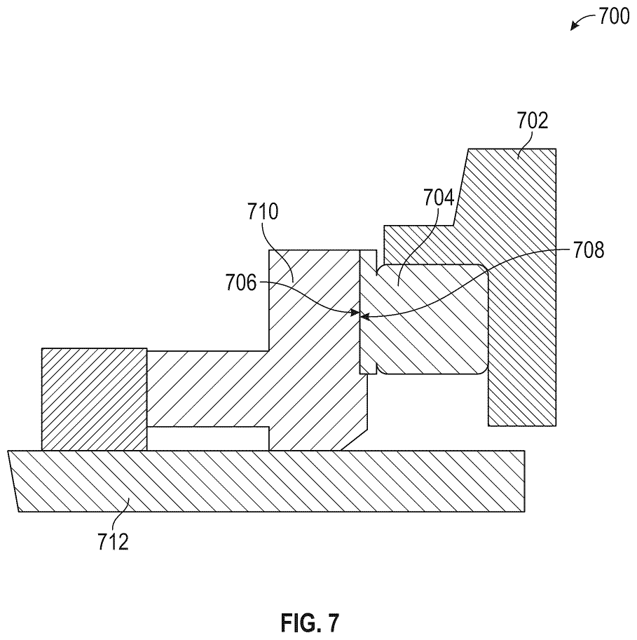

FIG. 7 is a cross-sectional view of a mechanical seal having a friction reducing coating and/or having a textured surface according to an embodiment of the present disclosure. FIG. 7 depicts a first mechanical seal assembly 700. As noted above, the friction reducing coating and/or the textured surface discussed herein can be applied to any surface that generates friction during normal operation. Mechanical seal assemblies, such as the first mechanical seal assembly 700 depicted in FIG. 7 include such surfaces. The first mechanical seal assembly 700 includes a stator, such as a stationary housing 702, and a rotor, such a seal runner 710 connected to a shaft 712. A seal is formed between the stationary housing 702 and the shaft 712. The stationary housing 702 includes a sealing element 704 having a contact region 706. The seal runner 710 has a surface 708 for contacting the contact region 706 of the sealing element 704. The contact region 706 and/or the surface 708 may be coated with a friction reducing coating and/or have a textured surface to reduce friction and/or wear associated with sliding motion of the seal runner 710 against the sealing element 704. The seal runner 710 may be in contact with a shaft 712 that may drive the sliding motion of the seal runner 710 against the sealing element 704. The sealing element 704 may be, for example, a carbon seal. The first mechanical seal assembly 700 may be, for example, a subassembly of any component disclosed herein having a mechanical seal.

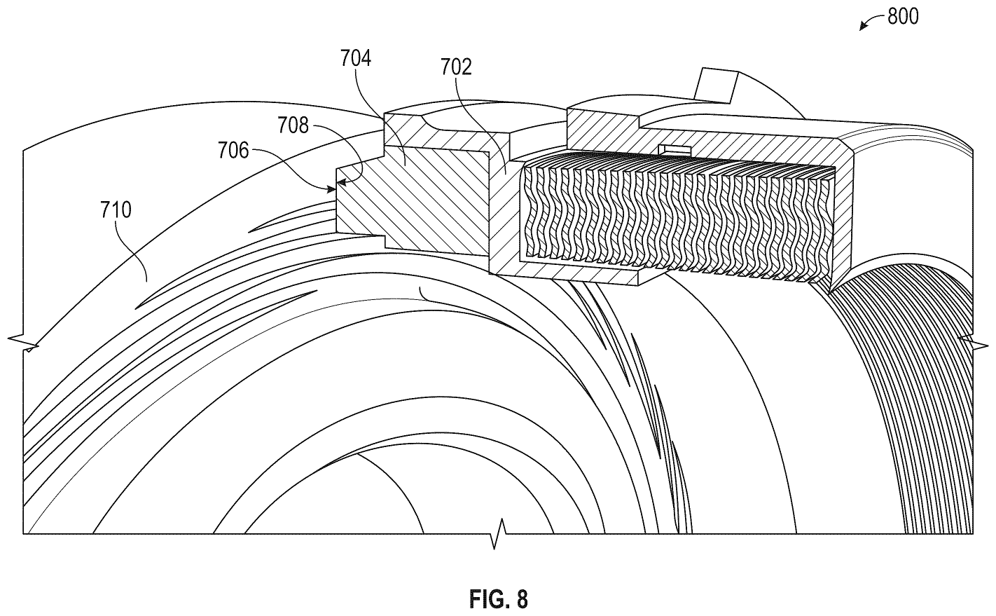

FIG. 8 is a partial cross-sectional view of a mechanical seal having a friction reducing coating and/or having a textured surface according to an embodiment of the present disclosure. FIG. 8 depicts a second mechanical seal assembly 800 including a stationary housing 702 for a sealing element 704 having a contact region 706 with a seal runner 710 with a surface 708. The contact region 706 and/or the surface 708 may be coated with a friction reducing coating and/or have a textured surface to reduce friction and/or wear associated with sliding motion of the seal runner 710 against the sealing element 704. The sealing element 704 may be, for example, a seal comprising, or consisting of, carbon (i.e., a carbon seal). The second mechanical seal assembly 800 may be, for example, a subassembly of any component disclosed herein having a mechanical seal.

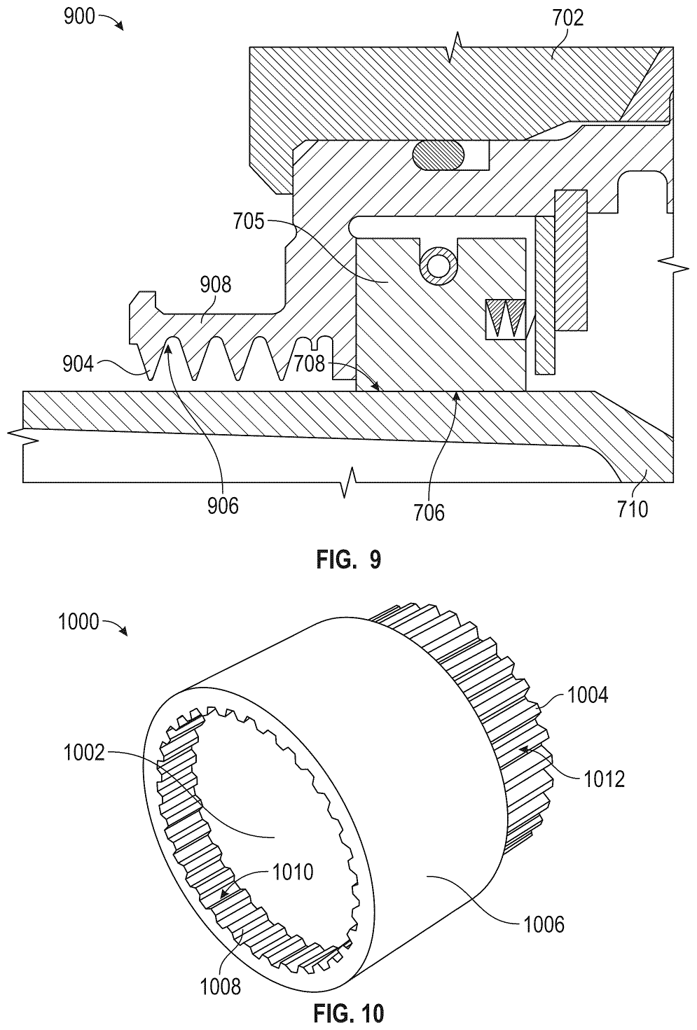

FIG. 9 is a partial cross-sectional view of a mechanical seal having a friction reducing coating and/or having a textured surface according to an embodiment of the present disclosure. FIG. 9 depicts a radial seal assembly 900 including a stationary housing 702 for a sealing element 704 having a contact region 706 with a seal runner 710 having a surface 708. The radial seal assembly depicted in FIG. 9 includes teeth 904, that contact the surface 708 of the seal runner 710. The teeth 904 are formed on a seal face 906 of a seal body 908 and extend from the seal face 906 towards the seal runner 710. The contact region 706 and/or teeth 904 may be coated with a friction reducing coating and/or have a textured surface to reduce friction and/or wear associated with sliding motion of the seal runner 710 against the sealing element 704 and/or teeth 904. Additionally, and/or alternatively, the surface 708 may be coated with a friction reducing coating and/or have a textured surface to reduce friction and/or wear associated with sliding motion of the seal runner 710 against the sealing element 704 and/or teeth 904. The seal runner 710 may be, for example, a carbon seal. The radial seal assembly 900 may be, for example, a subassembly of any component disclosed herein having a radial seal.

FIG. 10 is a schematic view of spline shafts having a friction reducing coating and/or having a textured surface according to an embodiment of the present disclosure. FIG. 10 depicts a spline shaft assembly 1000. As noted above, the friction reducing coating and/or the textured surface discussed herein can be applied to any surface that generates friction during normal operation. Spline assemblies, such as the spline shaft assembly 1000 depicted in FIG. 10, spline disk assemblies, or spline plate assemblies, include such surfaces. The spline shaft assembly depicted in FIG. 10 is includes an internal shaft 1002 with splines, referred to as internal splines 1004, and an external shaft 1006 with splines, referred to as external splines 1008. In the spline shaft assembly 1000 depicted in FIG. 8, the external shaft 1006 has a bore, the external splines 1008 are formed on a bore surface 1010 and project inward toward the bore. Likewise, the internal shaft 1002 has an outer surface 1012 and the internal splines 1004 are formed on the outer surface 1012 projecting outward from the internal shaft 1002. The internal shaft 1002 contacts the external shaft 1006, and the internal splines 1004 mesh with the external splines 1008 such that rotational motion of the internal shaft 1002 or the external shaft 1006 induces rotational motion of the external shaft 1006 or the internal shaft 1002, respectively. The internal splines 1004 internal shaft 1002 and/or the external splines 1008 external shaft 1006 may be coated with a friction reducing coating and/or have a textured surface to reduce friction and/or wear associated with motion of the internal shaft 1002 and/or the external shaft 1006. The spline shaft assembly 1000 may be, for example, a subassembly of any component disclosed herein that includes a spline shaft.

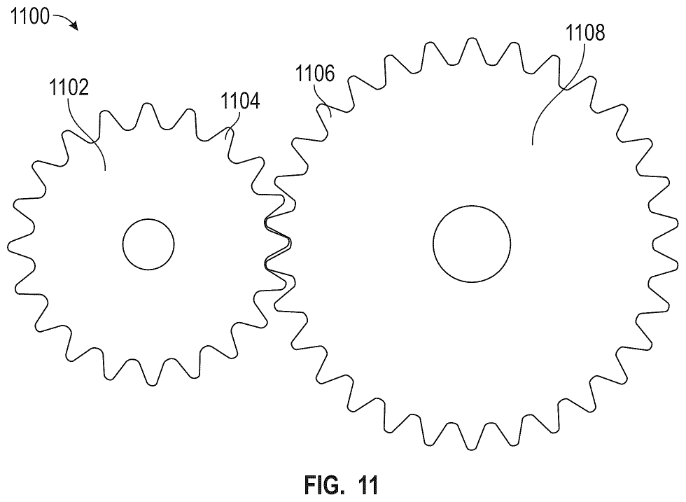

FIG. 11 is a schematic view of gears having a friction reducing coating and/or having a textured surface according to an embodiment of the present disclosure. FIG. 11 depicts a gear assembly 1100. The gear assembly includes a first gear 1102 and a second gear 1108. The first gear 1102 has teeth 1104, the second gear 1108 has teeth 1106. The teeth 1104 of the first gear 1102 contact the teeth 1106 of the second gear 1108 such that rotational motion of the first gear 1102 or the second gear 1108 induces rotational motion of the second gear 1108 or the first gear 1102, respectively. The teeth 1104 of the first gear 1102 and/or the teeth 1106 of the second gear 1108 may be coated with a friction reducing coating and/or have a textured surface to reduce friction and/or wear associated with motion of the first gear 1102 and/or the second gear 1108. The gear assembly 1100 may be, for example, a subassembly of any component disclosed herein such as, for example, the gearbox assembly 135.

The preceding discussion is by way of example only and the friction reducing coating and/or the textured surface may be applied to any substrate that could experience friction and/or wear. A coated component is any component including a substrate coated with the friction reducing coating, such as the bearings, gears, splines and seals discussed above. For example, the substrate may be a metal substrate, a ceramic substrate, carbon-based substrate, a metal substrate coated with a ceramic layer, a ceramic substrate coated with a metal layer, a metal substrate coated with a carbon-based layer, or a ceramic substrate coated with a carbon-based layer. The metal substrates may include, for example, iron-based alloys, nickel-based alloys, cobalt-based alloys, alloys containing cobalt and chromium, alloys containing platinum and aluminum, alloys containing nickel and aluminum, or alloys containing nickel, chromium, aluminum, and yttrium.

Fluid lubricants, such as oil, grease, a mineral oil, a synthetic oil, or any other liquid hydrocarbon, can be applied to any surface that generates friction during normal operation for, e.g., removing heat from hot metal parts as well as reducing friction. The inventors unexpectedly discovered that coatings including an amorphous metal and a solid lubricant dispersed throughout the coating can reduce friction between surface even in the absence of a fluid lubricant. In some embodiments, the coated component is free from fluid lubricants. The absence of a fluid lubricant may further improve the friction reduction of the coating by, for example, reducing viscous losses associated with flow of the fluid lubricant during use. The inventors also unexpectedly discovered that textured surfaces can reduce friction as compared to a smooth surface. Without wishing to be bound by theory, the textured surfaces may trap lubricant (e.g., a fluid lubricant) near the textured surface so as to reduce friction at the textured surface. These discoveries can be combined by, for example, texturing the surface of a coating including an amorphous metal and a solid lubricant and/or texturing a surface in contact with a coating including an amorphous metal and a solid lubricant.

Without wishing to be bound by theory, it is believed that the amorphous structure of the metal improves friction reduction as compared to more crystalline metal coatings. Moreover, it is believed that having the solid lubricant dispersed within the amorphous metal throughout the coating provides enhanced friction reduction by, for example, providing solid lubricant at points of contact both at the surface of the coating and within the coating as the coating deforms and/or wears during use. The solid lubricant can be dispersed within the amorphous metal as discrete particles by co-deposition with the bulk metallic glass by, for example, thermal spraying. After thermal spraying, the solid lubricant can migrate into microstructural regions of the coating.

As discussed in more detail below, the coated component can have, for example, a dry sliding friction coefficient greater than zero and less than 0.6 when sliding the coating against a steel disk.

The composition of the amorphous metal is not particularly limited. Some examples include amorphous iron-based metals, amorphous nickel containing alloys, amorphous molybdenum-based alloys, amorphous metal including niobium, and amorphous steel. In some embodiments, the amorphous metal comprises at least one of iron, chromium, molybdenum, cobalt, nickel, tungsten, boron, manganese, carbon, or silicon. In some embodiments, the amorphous metal is an iron-based alloy comprising at least two of chromium, molybdenum, tungsten, boron, manganese, carbon, or silicon. In some embodiments, the amorphous metal is an iron-based alloy comprising at least three of chromium, molybdenum, tungsten, boron, manganese, carbon, or silicon, and iron-based alloy comprising at least three of chromium, molybdenum, tungsten, boron, manganese, carbon, or silicon. In some embodiments, the amorphous metal is an iron-based alloy, a nickel-based alloy, a cobalt based alloy, a chromium-based alloy, or a molybdenum-based alloy.

The composition of the solid lubricant is not particularly limited. Some examples include tungsten disulfide, tantalum disulfide, hexagonal boron nitride, molybdenum disulfide, graphite, tungsten oxide, boron oxide, nickel oxide, talc, polytetrafluoroethylene, or a combination thereof. The solid lubricant can be included in the coating in any amount. For example, the coating may have an amount of the solid lubricant ranging from one weight percent to thirty weight percent by total weight of the coating. The amount of the solid lubricant may vary based on, for example, coating friction and coating wear.

The thickness of the friction reducing coating is not particularly limited. Depending on a composition of components, an expected contact force between the components, etc., a suitable coating thickness can be determined to account for, for example, wear rate of the friction reducing coating. For example, the friction reducing coating may have a thickness ranging from 0.1 microns to three hundred microns or any subrange contained therein. For example, the friction reducing coating may have a thickness ranging from one hundred microns to two hundred microns. Thickness ranging from one hundred microns to two hundred microns can ensure coating longevity throughout a lifetime of the component while the coating experiences wear.

The inventors unexpectedly found that texturing a surface can reduce friction when the textured surface is contacted by a contacting surface. Any of the surfaces disclosed above may be textured to reduce friction, including, for example, the friction reducing coating and/or a surface for contacting the friction reducing coating discussed above. For example, any surface on the disclosed components can include the textured surface and the contacting surface. Components including a textured surface and a contacting surface are referred to herein as a textured component. Texturing may be used in combination with a lubricant to reduce friction by, for example, trapping the lubricant near the textured surface.

It was unexpectedly found that surfaces having a roughness greater than 0.05 microns and less than two microns (e.g., greater than 0.05 microns and less than 0.5 microns) had reduced coefficients of friction as compared to a smoother surface. Surface roughness can be determined by, for example, contact profilometer or non-contact profilometry. In some embodiments, the friction reducing coating and/or a surface for contacting the friction reducing coating has a surface roughness greater than 0.05 microns and less than two microns. In some embodiments, the friction reducing coating and/or a surface for contacting the friction reducing coating has a surface roughness greater than 0.05 microns and less than 0.5 microns. The surface roughness can be tailored based on size features of the texturing. For example, a texture feature greater than two microns in size can have a surface roughness greater than 0.05 microns and less than 0.5 microns that is chosen based on various factors such as oil viscosity, surface energy, texture feature radius, and texture feature spacing. It was unexpectedly found that surfaces having a roughness within these ranges had reduced coefficients of friction has compared to a smoother surface.

During the course of evaluating the variations possible in the design, the inventors, discovered, unexpectedly, that there exists a relationship among select features of the textured component that produced superior results over the numerous other designs considered. This relationship is referred to by the inventors as the texture factor. The texture factor is defined by (A1/A2)*(Ra1/Ra2)*thickness, where the texture factor ranges from 0.01 to 0.75 had unexpectedly reduced coefficients of friction as compared to surfaces having a texture factor outside of this range. In the definition of the texture factor, A1 is an area of the textured surface (which may be, for example, a surface of a gear tooth (e.g., 1104 of FIG. 11) or a surfaces of a bearing (e.g., 308 or 309 of FIGS. 3 and 4)), A2 is an area of a contacting surface that contacts the textured surface (for example, an addendum and a dedendum surface of a gear tooth (e.g., 1106 of FIG. 11) or a total bearing surface (e.g., of the roller 302 of FIGS. 3 and 4)), Ra1 is a surface roughness of the textured surface, Ra2 is a surface roughness of the contacting surface (e.g., a gear mesh or non-textured surface), and the thickness is the thickness of an oil film in contact with the textured surface. In some embodiments, an area ratio A1/A2 ranges from 0.2 to 0.3. In some embodiments, Ra1 ranges from 0.1 microns to five microns. In some embodiments, Ra2 ranges from 0.1 microns to 0.3 microns. In some embodiments, the contacting surface is not textured. In some embodiments, the thickness of the oil film in contact with the textured surface ranges from 0.05 millimeter to 0.2 millimeter. In some embodiments, a texture dimension ranges from one hundred nanometers to one thousand nanometers. In some embodiments, a texture dimension ranges from one micron to one hundred microns. The texture dimension can be a submicron or micron scale feature that covers a surface dimension of texturing. Any of the disclosed surfaces may be textured with a texture factor ranging from 0.01 to 0.75 to reduce friction, including, for example, the friction reducing coating and/or a surface for contacting the friction reducing coating discussed above. For example, referring again to FIG. 11, one or more surfaces 608 of the squeeze film damper 602 may be coated with a friction reducing coating and/or have a textured surface to reduce friction and/or wear associated with motion of the bearing component 606 against the squeeze film damper 602, and, in some embodiments, the friction reducing coating is textured with a texture factor ranging from 0.01 to 0.75.

Friction reducing coatings can be prepared by a method that includes coating a surface of a component with the friction reducing coating by co-depositing an amorphous metal and a solid lubricant on the surface of the component. The friction reducing coating can be applied to a substrate by using various techniques. For example, the friction reducing coating can be applied to a substrate by physical vapor deposition or a thermal spray coating such as high velocity oxygen thermal spraying.

Surfaces can be textured using, for example, a laser or a lathe. Surfaces can be textured by cutting the surface with a diamond or engraving. Surfaces can also be textured by a fine cutting tool using periodic motion.

As discussed above, the friction reducing coating may be effective for reducing friction, for example, in bearings, gears, shafts, and etc.

### EXAMPLES

Specific embodiments will be demonstrated by reference to the following examples. These examples are disclosed solely by way of illustrating the present disclosure and should not be taken in any way to limit the scope of the present disclosure.

### Example One: Friction and Wear Reduction on Coating with an Amorphous Metal and Solid Lubricant

A disk was coated with a coating that included an amorphous metal and a solid lubricant. The amorphous metal had thirty weight percent iron, about twenty-five weight percent chromium, about twenty weight percent molybdenum, about ten weight percent tungsten, about five weight percent boron, about five weight percent manganese, about three weight percent carbon, and about two weight percent silicon by total weight of the amorphous metal. The solid lubricant was tungsten disulfide, and the coating was fifteen weight percent of the solid lubricant by total weight of the coating. The amorphous metal and the solid lubricant were blended at an eighty to fifteen weight ratio to afford a blended powder. The blended powder was then sprayed using a thermal spray process.

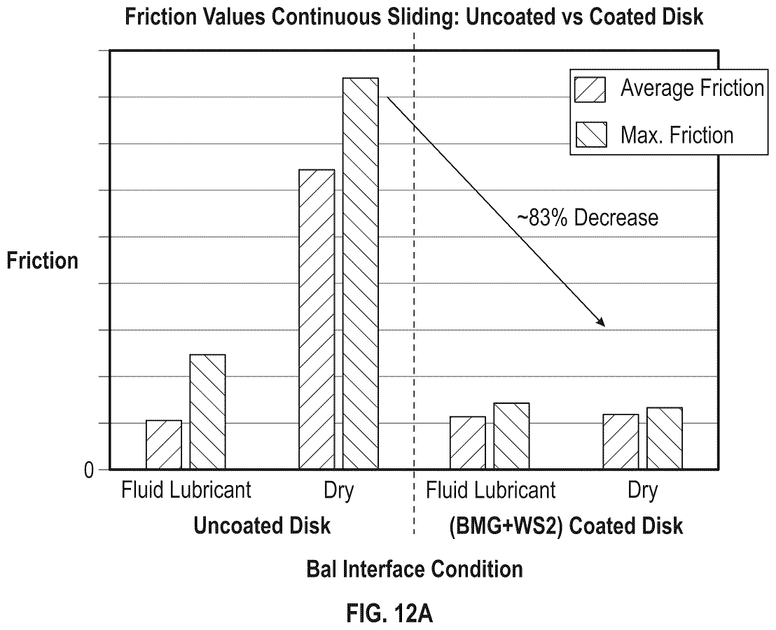

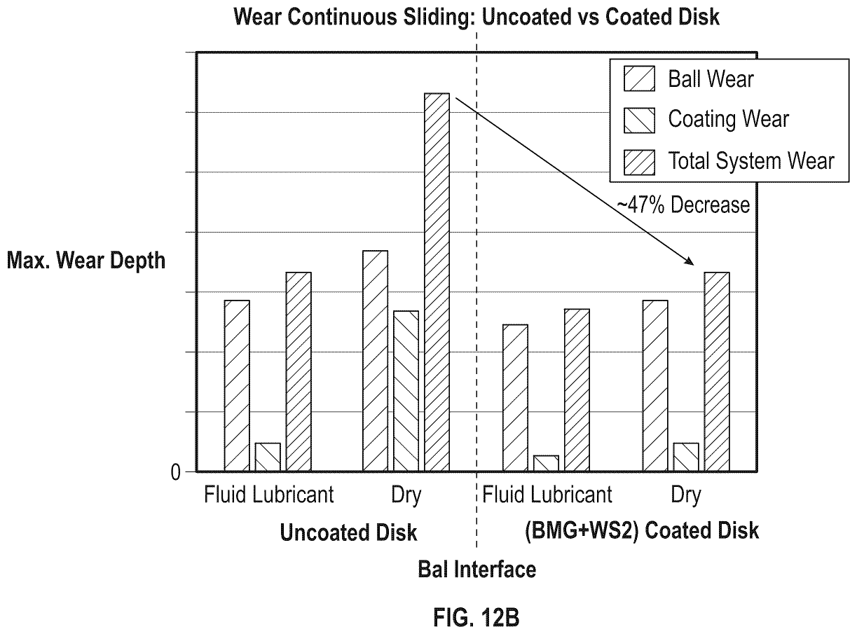

FIG. 12A depicts friction reduction data for a disk coated with a friction reducing coating according to an embodiment of the present disclosure. FIG. 12A depicts friction values of a dry uncoated steel disk, a uncoated steel disk with fluid lubricant, a dry steel disk coated with the coating that included the amorphous metal and the solid lubricant, and a steel disk coated with the coating that included the amorphous metal and the solid lubricant with fluid lubricant. FIG. 12A demonstrates that the steel disk coated with the coating that included the amorphous metal and the solid lubricant had a dramatically reduced friction coefficient as compared to the uncoated control.

FIG. 12B depicts wear reduction data for a disk coated with a friction reducing coating according to an embodiment of the present disclosure. FIG. 12B depicts wear values of a dry uncoated steel disk, a uncoated steel disk with fluid lubricant, between a steel disk coated with a fluid lubricant, an uncoated steel disk, and a dry steel disk coated with the coating that included the amorphous metal and the solid lubricant, and a steel disk coated with the coating that included the amorphous metal and the solid lubricant with fluid lubricant. FIG. 12B demonstrates that the steel disk coated with the coating that included the amorphous metal and the solid lubricant had dramatically reduced wear values as compared to the uncoated control.

### Example Two: Texturing to Reduce Friction

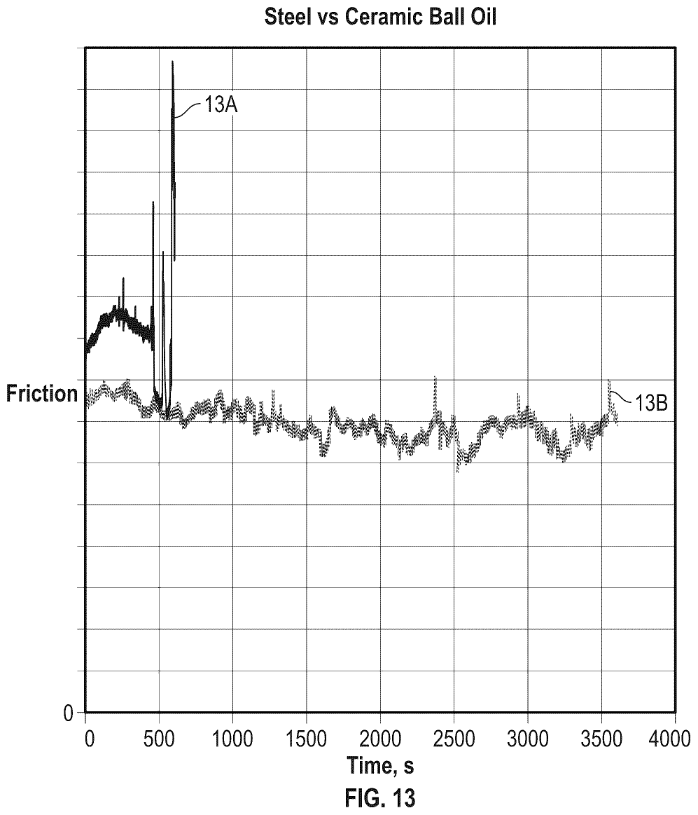

FIG. 13 depicts friction reduction for a textured surface as compared to a smooth surface. Line 13A depicts friction generated by sliding a ceramic ball having a surface roughness of 0.147 microns against a smooth steel disk having a surface roughness of 0.05 microns in the presence of a fluid lubricant.

Line 13B depicts friction generated by sliding a ceramic ball having a surface roughness of 0.147 microns against a textured steel disk having a surface roughness of 0.1736 microns in the presence of a fluid lubricant.

The textured surface (13B) had an unexpectedly lower coefficient of friction than the smoother surface (13A).

The results of these examples demonstrate an unexpected reduction in friction when surfaces are coated with an amorphous metal and solid lubricant and/or when surfaces are textured.

Further aspects of the present disclosure are provided by the subject matter of the following clauses.

A coating to reduce friction, the coating including an amorphous metal, and a solid lubricant, wherein the solid lubricant is dispersed with the amorphous metal throughout the coating or the solid lubricant is a layer on top of the amorphous metal.

The coating of the previous clause, such that the amorphous metal is an iron-based alloy.

The coating of any of the previous clauses, such that the amorphous metal comprises at least one of iron, chromium, molybdenum, cobalt, nickel, tungsten, boron, manganese, carbon, or silicon.

The coating of any of the previous clauses, such that the solid lubricant comprises tungsten disulfide, tantalum disulfide, hexagonal boron nitride, molybdenum disulfide, graphite, tungsten oxide, boron oxide, nickel oxide, talc, polytetrafluoroethylene, or a combination thereof.

The coating of any of the previous clauses, such that the coating has a surface roughness greater than 0.05 micron and less than two microns.

The coating of any of the previous clauses, such that the coating has a surface roughness greater than 0.05 micron and less than 0.5 micron.

The coating of any of the previous clauses, such that the coating has an amount of the solid lubricant ranging from one weight percent to thirty weight percent by total weight of the coating.

A textured component including the coating of any of the previous clauses coated on a substrate and a contacting surface positioned to contact the coating, wherein the coating is a textured surface in contact with an oil film, the textured component has a texture factor ranging from 0.01 to 0.75, the texture factor is defined by (A1/A2)*(Ra1/Ra2)*thickness, A1 is an area of the textured surface, A2 is an area of a contacting surface, Ra1 is a surface roughness of the textured surface, Ra2 is a surface roughness of the contacting surface, and the thickness is the thickness of the oil film.

A textured component including a textured surface in contact with an oil film and the coating of any of the previous clauses coated on a substrate having a contacting surface positioned to contact the textured surface, wherein the textured component has a texture factor ranging from 0.01 to 0.75, the texture factor is defined by (A1/A2)*(Ra1/Ra2)*thickness, A1 is an area of the textured surface, A2 is an area of a contacting surface, Ra1 is a surface roughness of the textured surface, Ra2 is a surface roughness of the contacting surface, and the thickness is the thickness of the oil film.

A coated component including the coating of any of the previous clauses coated on a substrate.

The coated component of any of the previous clauses, such that the substrate is an iron-based alloy.

The coated component of any of the previous clauses, such that the coated component is free from fluid lubricants.

The coated component of any of the previous clauses, such that the coated component is a bearing component, a gear, or a spline shaft.

The coated component of any of the previous clauses, such that the coated component is a bearing having a raceway, the coating being applied to a surface of the raceway.

The coated component of any of the previous clauses, such that the coated component is a seal comprising a rotor having a rotor surface and a stator having a stator surface in contact with the rotor surface, wherein the coating is applied to the rotor surface, the stator surface, or both.

The coated component of any of the previous clauses, such that the coated component is a roller bearing having a roller, the substrate being at least a portion of the roller.

The coated component of any of the previous clauses, such that the substrate is an end portion of the roller of a roller bearing or a shoulder portion of the roller.

The coated component of any of the previous clauses, such that the roller is one of a ball, a cylindrical roller, a tapered roller, or a needle roller.

A gas turbine engine including the coated component of any of the previous clauses, such that the substrate is a portion of one or more of a fan bearing, a shaft, a pitch bearing, a bushing, or a gear box.

An aircraft including the coated component of any of the previous clauses, such that the substrate is a portion of one or more of a fan bearing, a shaft, a pitch bearing, or a gear box.

A method of coating a component, the method including coating a surface of the component with the coating of any of the previous clauses by co-depositing the amorphous metal and the solid lubricant on the surface of the component, or depositing the amorphous metal and then depositing the solid lubricant on top of the amorphous metal.

A coating to reduce friction, the coating including an amorphous metal, and a solid lubricant.

The coating of the preceding clause such that the solid lubricant is dispersed with the amorphous metal throughout the coating.

The coating of any preceding clause such that the amorphous metal is an iron-based alloy.

The coating of any preceding clause such that the amorphous metal includes at least one of iron, chromium, molybdenum, tungsten, boron, manganese, carbon, or silicon.

The coating of any preceding clause such that the amorphous metal is an iron-based alloy including at least two of chromium, molybdenum, tungsten, boron, manganese, carbon, or silicon.

The coating of any preceding clause such that the amorphous metal is an iron-based alloy including at least three of chromium, molybdenum, tungsten, boron, manganese, carbon, or silicon.

The coating of any preceding clause such that the solid lubricant includes tungsten disulfide, tantalum disulfide, hexagonal boron nitride, molybdenum disulfide, graphite, tungsten oxide, boron oxide, nickel oxide, talc, polytetrafluoroethylene, or a combination thereof.

The coating of any preceding clause such that the coating has a surface roughness greater than 0.05 micron and less than two microns.

The coating of any preceding clause such that the coating has a surface roughness greater than 0.05 micron and less than 0.5 micron.

The coating of any preceding clause such that the coating has an amount of the solid lubricant ranging from one weight percent to thirty weight percent by total weight of the coating.

A textured component including the coating of any preceding clause coated on a substrate and a contacting surface positioned to contact the coating, such that the coating is a textured surface, the textured component has a texture factor ranging from 0.01 to 0.75, the texture factor is defined by (A1/A2)*(Ra1/Ra2)*thickness, A1 is an area of the textured surface, A2 is an area of a contacting surface, Ra1 is a surface roughness of the textured surface, Ra2 is a surface roughness of the contacting surface, and the thickness is the thickness of the textured surface.

A textured component including a textured surface and the coating of any preceding clause coated on a substrate having a contacting surface positioned to contact the textured surface, wherein the textured component has a texture factor ranging from 0.01 to 0.75, the texture factor is defined by (A1/A2)*(Ra1/Ra2)*thickness, A1 is an area of the textured surface, A2 is an area of a contacting surface, Ra1 is a surface roughness of the textured surface, Ra2 is a surface roughness of the contacting surface, and the thickness is the thickness of the textured surface.

A coated component including the coating of any preceding clause coated on a substrate.

The coated component of the preceding clause such that the substrate is an iron-based alloy.

The coated component of the preceding clause such that the substrate is a bearing component, a gear, or a spline shaft.

The coated component of the preceding clause such that the substrate is a bearing raceway, a squeeze film damper, a ball of a ball bearing, a tapered roller of a roller bearing, a cylindrical roller of a roller bearing, a journal bearing component, or a needle roller of a roller bearing.

The coated component of the preceding clause such that the substrate is an end portion of a roller of a roller bearing or a shoulder portion of a roller of a roller bearing.

The coated component of any preceding clause such that the coated component is a bearing component, a gear, or a spline shaft.

The coated component of any preceding clause such that the coated component is a bearing having a raceway, the coating being applied to a surface of the raceway.

The coated component of any preceding clause such that the coated component is a roller bearing having a roller, the substrate being at least a portion of the roller.

The coated component of any preceding clause such that the substrate is an end portion of the roller of a roller bearing or a shoulder portion of the roller.

The coated component of any preceding clause such that the roller is one of a ball, a cylindrical roller, a tapered roller, or a needle roller.

The coated component of any preceding clause such that the coated component is a seal comprising a rotor having a rotor surface and a stator having a stator surface in contact with the rotor surface, wherein the coating is applied to the rotor surface, the stator surface, or both.

A gas turbine engine including the coated component of any preceding clause such that the substrate is a portion of one or more of a fan bearing, a shaft, a pitch bearing, or a gear box.

An aircraft including the coated component of any preceding clause such that the substrate is a portion of one or more of a fan bearing, a shaft, a pitch bearing, or a gear box.

A method of coating a component, the method including coating a surface of the component with the coating of any preceding clause by co-depositing the amorphous metal and the solid lubricant on the surface of the component.

A textured component comprising a textured surface having an area A1, a thickness, a surface roughness Ra1, and a contacting surface having an area A2 and a surface roughness Ra2, such that the component has a texture factor, defined by (A1/A2)*(Ra1/Ra2)*thickness, and the texture factor ranges from 0.01 to 0.75.

The textured component of the preceding clause such that the area ratio A1/A2 ranges from 0.2 to 0.3.

The textured component of any preceding clause such that Ra1 ranges from 0.1 micron to five microns.

The textured component of any preceding clause such that Ra2 ranges from 0.1 micron to 0.3 micron.

The textured component of any preceding clause such that the contacting surface is not textured.

The textured component of any preceding clause such that the thickness of the textured surface ranges from 0.05 millimeter to 0.2 millimeter.

The textured component of any preceding clause such that the textured surface is a coating to reducing friction of any of the preceding clauses.

The textured component of any preceding clause such that the contacting surface is a coating to reducing friction of any of the preceding clauses.

The textured component of any preceding clause such that the textured surface is on a substrate.

The textured component of any preceding clause such that the substrate is an iron-based alloy.

The textured component of any of the previous clauses, such that the textured component is free from fluid lubricants.

The textured component of the preceding clause such that the substrate is a bearing component, a gear, or a spline shaft.

The textured component of the preceding clause such that the substrate is a bearing raceway, a squeeze film damper, a ball of a ball bearing, a tapered roller of a roller bearing, a cylindrical roller of a roller bearing, a journal bearing component, or a needle roller of a roller bearing.

The textured component of the preceding clause such that the substrate is an end portion of a roller of a roller bearing or a shoulder portion of a roller of a roller bearing.

A gas turbine engine including the textured component of any preceding clause such that the substrate is a portion of one or more of a fan bearing, a shaft, a pitch bearing, or a gear box.

An aircraft including the textured component of any preceding clause such that the substrate is a portion of one or more of a fan bearing, a shaft, a pitch bearing, or a gear box.

Although the foregoing description is directed to some exemplary embodiments of the present disclosure, other variations and modifications will be apparent to those skilled in the art, and may be made without departing from the present disclosure. Moreover, features described in connection with one embodiment of the present disclosure may be used in conjunction with other embodiments, even if not explicitly stated above.

1. A coating to reduce friction, the coating comprising:
an amorphous metal; and
a solid lubricant,
wherein the solid lubricant is dispersed with the amorphous metal throughout the coating, or the solid lubricant is a layer on top of the amorphous metal.

2. The coating of claim 1, wherein the amorphous metal is an iron-based alloy.

3. The coating of claim 1, wherein the amorphous metal comprises at least one of iron, chromium, molybdenum, cobalt, nickel, tungsten, boron, manganese, carbon, or silicon.

4. The coating of claim 1, wherein the solid lubricant comprises tungsten disulfide, tantalum disulfide, hexagonal boron nitride, molybdenum disulfide, graphite, tungsten oxide, boron oxide, nickel oxide, talc, polytetrafluoroethylene, or a combination thereof.

5. The coating of claim 1, wherein the coating has a surface roughness greater than 0.05 micron and less than two microns.

6. The coating of claim 1, wherein the coating has a surface roughness greater than 0.05 micron and less than 0.5 micron.

7. The coating of claim 1, wherein the coating has an amount of the solid lubricant ranging from one weight percent to thirty weight percent by total weight of the coating.

8. A textured component comprising the coating of claim 1 coated on a substrate and a contacting surface positioned to contact the coating, wherein the coating is a textured surface in contact with an oil film, the textured component has a texture factor ranging from 0.01 to 0.75, the texture factor is defined by (A1/A2)*(Ra1/Ra2)*thickness, A1 is an area of the textured surface, A2 is an area of a contacting surface, Ra1 is a surface roughness of the textured surface, Ra2 is a surface roughness of the contacting surface, and the thickness is the thickness of the oil film.

9. A textured component comprising a textured surface in contact with an oil film and the coating of claim 1 coated on a substrate having a contacting surface positioned to contact the textured surface, wherein the textured component has a texture factor ranging from 0.01 to 0.75, the texture factor is defined by (A1/A2)*(Ra1/Ra2)*thickness, A1 is an area of the textured surface, A2 is an area of a contacting surface, Ra1 is a surface roughness of the textured surface, Ra2 is a surface roughness of the contacting surface, and the thickness is the thickness of the oil film.

10. A coated component comprising the coating of claim 1 coated on a substrate.

11. The coated component of claim 10, wherein the coated component is free from fluid lubricants.

12. The coated component of claim 10, wherein the coated component is a bearing component, a gear, or a spline shaft.

13. The coated component of claim 10, wherein the coated component is a bearing having a raceway, the coating being applied to a surface of the raceway.

14. The coated component of claim 10, wherein the coated component is a seal comprising a rotor having a rotor surface and a stator having a stator surface in contact with the rotor surface, wherein the coating is applied to the rotor surface, the stator surface, or both.

15. The coated component of claim 10, wherein the coated component is a roller bearing having a roller, the substrate being at least a portion of the roller.

16. The coated component of claim 15, wherein the substrate is an end portion of the roller of a roller bearing or a shoulder portion of the roller.

17. The coated component of claim 15, wherein the roller is one of a ball, a cylindrical roller, a tapered roller, or a needle roller.

18. A gas turbine engine comprising the coated component of claim 10, wherein the substrate is a portion of one or more of a fan bearing, a shaft, a pitch bearing, a bushing, or a gear box.

19. An aircraft comprising the coated component of claim 10, wherein the substrate is a portion of one or more of a fan bearing, a shaft, a pitch bearing, or a gear box.

20. A method of coating a component, the method comprising:
coating a surface of the component with the coating of claim 1 by co-depositing the amorphous metal and the solid lubricant on the surface of the component; or
depositing the amorphous metal and then depositing the solid lubricant on top of the amorphous metal.
